(19) United States
(12) Patent Application Publication
(10) Pub. No.: US 2008/0174874 A1
(43) Pub. Date: Jul. 24, 2008

(54) LIGHT DIFFUSING RESIN COMPOSITION

(75) Inventor: Hiroko KANAYA, Ehime (JP)

Correspondence Address: SUGHRUE MION, PLLC, 2100 PENNSYLVANIA AVENUE, N.W., SUITE 800, WASHINGTON, DC, 20037, US

(73) Assignee: SUMITOMO CHEMICAL COMPANY, LIMITED, Tokyo (JP)

(21) Appl. No.: 11/876,187

(22) Filed: Oct. 22, 2007

(30) Foreign Application Priority Data
Oct. 24, 2006 (JP) P2006-288481

(51) Int. Cl. G02B 5/02; F21V 23/00

(52) U.S. Cl. 359/599; 362/260

(57) ABSTRACT

A light diffusing resin composition containing a transparent resin, a light diffuser and a dye having a maximum absorption wavelength (λ_{Amax}) in a range of 470 nm to 520 nm or a range of 570 nm to 610 nm and a maximum fluorescence wavelength (λ_{Pmax}) in a range of 380 nm to 470 nm, a range of 520 nm to 570 nm or a range of 610 nm to 700 nm.

### FIELD OF THE INVENTION

The present invention relates to a light diffusing resin composition having good color reproducibility.

### DESCRIPTION OF THE BACKGROUND ART

A light diffusing resin composition comprising a light diffuser in a transparent resin is useful as a material constituting a light diffuser plate.

For example, a light diffuser plate (1) is used as an element of a surface light source unit (2) as shown in FIG. 1. The surface light source unit (2) comprises a light diffuser plate (1) and cold cathode fluorescent lamps (CCFL) (3). The cold cathode fluorescent lamps (3) are provided on the back face side of the light diffuser plate (1), and light emitted from the CCFL (3) passes through the light diffuser plate (1) while being diffused by the plate (1), and exits from the front face of the light diffuser plate (1).

The surface light source unit (2) is assembled into a transmissive image display (4). The transmissive image display has a transmissive color image-displaying element (5) on the front face side of the surface light source unit (2). For example, the transmissive color image-displaying element (5) comprises a color filter (51) having red pixels, green pixels and blue pixels which are arranged in a lattice pattern, a liquid crystal cell (52) provided on the front face side of the color filter (51), and polarizing films (53) provided on the both surfaces of the liquid crystal cell (52). The transmissive image display (4) of FIG. 1 displays a color image when the transmissive color image-displaying element (5) is illuminated from its back face side by the surface light source unit (2) (cf. JP-A-2001-305335).

However, the light diffuser plate (1) made of a conventional light diffusing resin composition does not necessarily display a color image with satisfactory color reproducibility.

### SUMMARY OF THE INVENTION

An object of the present invention is to provide a light diffusing resin composition which can provide a light diffuser plate that allows a transmissive image display to display a color image with better color reproducibility.

Accordingly, the present invention provides a light diffusing resin composition comprising a transparent resin, a light diffuser and a dye having a maximum absorption wavelength (λ_{Amax}) in a range of 470 nm to 520 nm or a range of 570 nm to 610 nm and a maximum fluorescence wavelength (λ_{Pmax}) in a range of 380 nm to 470 nm, a range of 520 nm to 570 nm or a range of 610 nm to 700 nm.

The light diffusing resin composition of the present invention is useful as a material of a light diffuser plate, and a surface light source unit comprising such a light diffuser plate can provide a transmissive image display having good color reproducibility of a color image.

### BRIEF DESCRIPTION OF THE DRAWINGS

FIG. 1 is a schematic cross sectional view of a transmissive image display comprising a surface light source unit and a transmissive color image-displaying unit.

### DETAILED DESCRIPTION OF THE INVENTION

As a transparent resin used according to the present invention, any transparent resin, that is used for the production of conventional light diffuser plate, may be used. Specific examples of the transparent resin include polystyrene resins, methacrylic resins, polycarbonate resins, acrylonitrile-styrene-butadiene copolymer resins (ABS resins), methyl methacrylate-styrene copolymer resins (MS resins), acrylonitrile-styrene copolymer resins (AS resins), polyolefin resins (e.g. polyethylene, polypropylene, etc.), cycloolefin resins, etc.

The light diffuser used according to the present invention may be a compound which is incompatible with the transparent resin and has a refractive index difference of usually 0.01 to 0.3, preferably 0.05 to 0.2 in comparison with the refractive index of the transparent resin, and a weight average particle size of usually 1 to 15 μm, preferably 2 to 10 μm. Specific examples of the light diffuser include inorganic particles such as glass beads, silica particles, aluminum hydroxide particles, calcium carbonate particles, barium carbonate particles, titanium oxide particles, talc, etc.; and organic particles such as polystyrene resin particles, acrylic resin particles, silicone particles, etc.

The content of the light diffuser in the transparent resin composition of the present invention depends on the type of the light diffuser plate to be produced. For example, the transparent resin composition usually contains 0.1 to 10 parts by weight, preferably 0.3 to 7 parts by weight of the light diffuser per 100 parts by weight of the transparent resin, so that the content of the light diffuser in a unit area of the light diffuser plate is usually 2 to 200 g/m², preferably 3 to 70 g/m².

The dye used according to the present invention has a maximum absorption wavelength (λ_{Amax}) in a range of 470 nm to 520 nm or a range of 570 nm to 610 nm and a maximum fluorescence wavelength (λ_{Pmax}) in a range of 380 nm to 470 nm, a range of 520 nm to 570 nm or a range of 610 nm to 700 nm. Specific examples of the dye having such properties include dyes having a maximum absorption wavelength (λ_{Amax}) in a range of 470 nm to 520 nm and a maximum fluorescence wavelength (λ_{Pmax}) in a range of 520 nm to 570 nm (e.g. NK 5705 (available from Hayashibara Biochemical Laboratories Inc.; λ_{Amax}=492 nm; λ_{Pmax}=548 nm), Atto 475 NHSester (available from Fluka; λ_{Amax}=475 nm; λ_{Pmax}=522 nm), etc.); dyes having a maximum absorption wavelength (λ_{Amax}) in a range of 570 nm to 610 nm and a maximum fluorescence wavelength (λ_{Pmax}) in a range of 610 nm to 700 nm (e.g. Crystal Violet Perchlorate (available from Fluka; λ_{Amax}=606 nm; λ_{Pmax}=632 nm), etc.); dyes having a maximum absorption wavelength (λ_{Amax}) in a range of 470 nm to 520 nm and a maximum fluorescence wavelength (λ_{Pmax}) in a range of 610 nm to 700 nm (e.g. 4-dicyanomethylene)-2-methyl-6-(p-dimethylaminostyryl)-4H-pyran (λ_{Amax}=480 nm; λ_{Pmax}=627 nm); and the like.

The content of the dye is usually from 0.00001 to 0.01 part by weight, preferably from 0.00001 to 0.005 part by weight based on 100 parts by weight of the total weight of the components of the light diffusing resin composition except the dye. It is also preferable that the dye is contained in the composition so that the content of the dye in a unit area of the light diffuser plate is usually from 0.0002 to 0.2 g/cm³, preferably 0.002 to 0.1 g/cm³.

The light diffusing resin composition of the present invention may contain various conventional additives such as a stabilizer (e.g. an UV ray absorbing agent, an antioxidant, etc.), a flame retarder, a mold release agent, and the like.

When a thermoplastic resin is used as a transparent resin, the light diffusing resin composition of the present invention may be prepared by melt-kneading the transparent resin together with the light diffuser and the dye. The light diffuser and the dye as such are mixed with the transparent resin and melt-kneaded. In other method, the light diffuser and the dye are melt-kneaded with a small amount of a transparent resin at high concentrations of the light diffuser and the dye to prepare a master batch and then the master batch and the transparent resin are melt-kneaded.

When a thermosetting resin is used as a transparent resin, the light diffusing resin composition of the present invention may be prepared by mixing the light diffuser and the dye with the precursor of the thermosetting resin prior to curing and then curing the mixture.

Alternatively, the light diffusing resin composition of the present invention may be prepared by mixing a monomer or monomers of a transparent resin with the light diffuser, the dye and also a polymerization initiator to obtain a monomer mixture and then polymerizing the monomer mixture.

When the light diffusing resin composition of the present invention comprises a thermoplastic resin as a transparent resin, a light diffuser plate may be produced by molding the light diffusing resin composition in a molten state. The light diffusing resin composition may be molded by any conventional method such as extrusion molding, injection molding, press molding, etc.

When the light diffusing resin composition of the present invention comprises a thermosetting resin as a transparent resin, a light diffuser plate may be produced by mixing the light diffuser and the dye with the precursor of the thermosetting resin, supplying the mixture into a mold and then curing the mixture in the mold.

When the monomer mixture containing the monomer(s), the light diffuser and the dye is used, a light diffuser plate may be produced by supplying the monomer mixture into a mold and then polymerizing the monomer mixture in the mold.

The light diffuser plate made of the light diffusing resin composition of the present invention usually has a thickness of 1 mm to 3 mm.

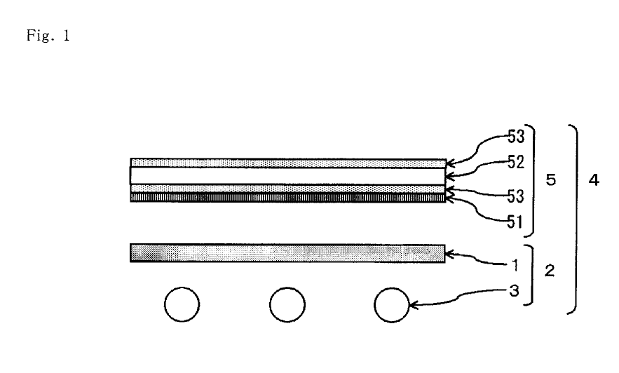

The light diffuser plate is generally used as a light diffuser plate (1) constituting a surface light source unit (2) as shown in FIG. 1. The surface light source unit (2) comprises the light diffuser plate (1) and cold cathode fluorescent lamps (CCFL) (3). The cold cathode fluorescent lamps (3) are provided on the back face side of the light diffuser plate (1), and light emitted from the CCFL (3) passes through the light diffuser plate (1) while being diffused by the plate (1), that is, the light diffuser contained in the plate (1), and exits from the front face of the light diffuser plate (1).

The surface light source unit (2) constitutes a transmissive image display (4). The transmissive image display (4) comprises a transmissive color image-displaying element (5) on the front face side of the surface light source unit (2). The transmissive color image-displaying element (5) comprises a color filter (51) having red pixels, green pixels and blue pixels which are arranged in a lattice pattern, a liquid crystal cell (52) provided on the front face side of the color filter (51), and polarizing films (53) provided on the both surfaces of the polarizing film (52).

The present invention will be illustrated by the following Examples, which do not limit the scope of the invention in any way.

The average particle size of a light diffuser was measured with a light diffusion-scattering particle size measuring device (a microtrack particle size analyzer Model 9220 FRA manufactured by NIKKISO CO., LTD.).

### EXAMPLE 1

A light diffuser plate having a thickness of 2 mm was produced by melt-kneading and extrusion molding, at 250° C., a mixture containing 98.8 parts by weight of a polystyrene resin (T 080 manufactured by TOYO-STYRENE CO., LTD.; refractive index: 1.59), 0.0002 part by weight of a fluorescent dye (NK 5705 (1,3-diethyl-5-[2-(1-heptyl-1,3-dihydro-3,3-dimethyl-2H-indol-2-ylidene)ethylidene]dihydro-2-thioxo-4,6-(1H,5H)-pyrimidinedione) manufactured by Hayashibara Biochemical Laboratories Inc.; λ_{Amax}=492 nm, λ_{Pmax}=548 nm), 0.86 part by weight of acrylic resin particles as a light diffuser (XX 66K manufactured by SEKISUI PLASTICS CO., LTD.; weight average particle size: 2 μm; refractive index: 1.49) and 0.14 part by weight of silicone particles as a light diffuser (DY 33-719 manufactured by Toray Dow Corning Silicone Co., Ltd.; weight average particle size: 2 μm; refractive index: 1.42).

As shown in FIG. 1, the light diffuser plate produced above was mounted as the light diffuser plate (1) on a commercially sold transmissive image display (4) (screen size: 20 inches (diagonal length of 500.3 mm)), which comprised the surface light source unit (2) having the light diffuser plate (1) and the CCFL (3), and the color image-displaying element (5) on the front face side of the surface light source unit (2). Then, a white image was displayed on the screen of the transmissive image display (4), and the luminance and color reproducibility of the display were measured. The luminance was 502 cd/m², and the color reproducibility was 77.1%.

The luminance was measured with a multi-luminance meter (Eye-Scale 3W,4W manufactured by I System Corporation) and averaged over the entire display screen.

The color reproducibility was evaluated as follows:

A color reproduction range of a displayed color image was obtained on a CIE chromaticity diagram defined by Commission Internationale de l'Eclairage, and then a color reproducibility was calculated as an area ratio (Gₐₘᵤₜ) in relation to the color reproduction range defined by National Television System Committee (NTSC).

### COMPARATIVE EXAMPLE 1

A light diffuser plate was produced in the same manner as in Example 1 except that 0.0002 part by weight of a non-fluorescent dye (NK 1413 manufactured by Hayashibara Biochemical Laboratories Inc.; λ_{Amax}=497 nm) was used in place of the fluorescent dye (NK 5705), and a luminance and a color reproducibility were measured. The luminance was 422 cd/m², and the color reproducibility (Gₐₘᵤₜ) was 74.8%.

### COMPARATIVE EXAMPLE 2

A light diffuser plate was produced in the same manner as in Example 1 except that no fluorescent dye was used, and a luminance and a color reproducibility were measured. The luminance was 487 cd/m², and the color reproducibility (Gₐₘᵤₜ) was 73.8%.

What is claimed is:

1. A light diffusing resin composition comprising a transparent resin, a light diffuser and a dye having a maximum absorption wavelength (λ_{Amax}) in a range of 470 nm to 520 nm or a range of 570 nm to 610 nm and a maximum fluorescence wavelength (λ_{Pmax}) in a range of 380 nm to 470 nm, a range of 520 nm to 570 nm or a range of 610 nm to 700 nm.

2. The light diffusing resin composition according to claim 1, wherein the dye has a maximum absorption wavelength in a range of 470 nm to 520 nm and a maximum fluorescence wavelength in a range of 520 nm to 570 nm.

3. The light diffusing resin composition according to claim 1, wherein the dye has a maximum absorption wavelength in a range of 570 nm to 610 nm and a maximum fluorescence wavelength in a range of 610 nm to 700 nm.

4. The light diffusing resin composition according to claim 1, wherein the dye has a maximum absorption wavelength in a range of 470 nm to 520 nm and a maximum fluorescence wavelength in a range of 610 nm to 700 nm.

5. A light diffuser plate comprising a light diffusing resin composition according to claim 1.

6. A surface light source unit comprising a light diffuser plate according to claim 5, and at least one cold cathode fluorescent lamp provided on a back face side of the light diffuser plate.

7. A transmissive image display comprising a surface light source unit according to claim 6, and a transmissive color image-displaying element provided on a front face side of the surface light source unit.
